(19) United States
(12) Patent Application Publication
(10) Pub. No.: US 2025/0348973 A1
(43) Pub. Date: Nov. 13, 2025

(54) IMAGE GENERATION METHOD AND APPARATUS

(71) Applicant: Beijing Zitiao Network Technology Co., Ltd., Beijing (CN)

(72) Inventors: Shupeng ZHANG, Beijing (CN); Yifan JIANG, Beijing (CN)

(21) Appl. No.: 18/861,359

(22) PCT Filed: Mar. 30, 2023
(86) PCT No.: PCT/CN2023/085006

§ 371 Date: Oct. 29, 2024

(30) Foreign Application Priority Data
Apr. 29, 2022 (CN) 202210476306.9

(51) Int. Cl. G06T 5/50; G06T 15/50; G06T 17/20

(52) U.S. Cl. CPC G06T 5/50; G06T 15/506; G06T 17/20; G06T 2207/20221; G06T 2207/30196

(57) ABSTRACT

The embodiments of the present disclosure relate to the technical field of image processing. Provided are an image generation method and apparatus. The method comprises: acquiring a first image that comprises a target object; performing illumination estimation on the first image so as to acquire illumination information of the first image; rendering a target garment model according to the illumination information so as to generate a second image; and fusing the first image with the second image to acquire an effect image after the target object wears a virtual garment corresponding to the target garment model.

### CROSS-REFERENCE TO RELATED APPLICATIONS

The present application is based on and claims priority to Chinese Patent Application No. 202210476306.9 filed on Apr. 29, 2022, the disclosure of which is incorporated by reference herein in its entirety.

### TECHNICAL FIELD

The present disclosure relates to a technical field of image processing, and particularly to an image generation method and apparatus.

### BACKGROUND

Virtual Try-On refers to an effect image after a try-on object tries on new clothes being output though virtual technical means. Since the virtual try-on technology can enable viewing an effect after changing into new clothes without a user taking off/putting on clothes, it greatly improves the efficiency of trying on clothes, and thus the virtual try-on has a very wide usage prospect.

### SUMMARY

Embodiments of the present disclosure provide technical solutions as follows.

In a first aspect, an embodiment of the present disclosure provides an image generation method comprising:
acquiring a first image including a target object;
performing an illumination estimation on the first image to acquire illumination information of the first image;
rendering a target garment model according to the illumination information to generate a second image; and
fusing the first image and the second image to acquire an effect image for the target object wearing a virtual garment corresponding to the target garment model.

As an optional implementation of the embodiment of the present disclosure, the method further comprises:
constructing a first model corresponding to the target object according to the first image;
determining a garment state of the target garment model corresponding to the target object according to the first model;
the rendering the target garment model according to the illumination information to generate the second image comprises rendering the target garment model according to the garment state of the target garment model corresponding to the target object and the illumination information to generate the second image.

As an optional implementation of the embodiment of the present disclosure, the constructing the first model corresponding to the target object according to the first image comprises:
performing a key point detection on the target object to acquire position information of a plurality of key points of the target object;
acquiring a body shape and/or a posture of the target object according to the position information of the plurality of key points;
constructing the first model according to the body shape and/or the posture of the target object.

As an optional implementation of the embodiment of the present disclosure, the method further comprises:
receiving a correction operation on the body shape and/or the posture of the first model;
correcting the body shape and/or the posture of the first model in response to the correction operation on the body shape and/or the posture of the first model.

As an optional implementation of the embodiment of the present disclosure, the determining the garment state of the target garment model corresponding to the target object according to the first model comprises:
constructing a second model corresponding to the target object according to an initial state of the target garment model;
determining the garment state of the target garment model corresponding to the target object according to the first model and the second model.

As an optional implementation of the embodiment of the present disclosure, the determining the garment state of the target garment model corresponding to the target object according to the first model and the second model comprises:
generating a sequence of models according to the first model and the second model, the sequence of models including a plurality of models, and the plurality of models gradually changing from the second model to the first model in order;
performing a simulation on the target garment model in the initial state based on the first model in the sequence of models to acquire a garment state corresponding to the first model;
performing the simulation on the target garment model in a garment state corresponding to the (n−1)th model based on the nth model in the sequence of models to acquire a garment state corresponding to the nth model, n being an integer greater than 1;
determining a garment state corresponding to the last model in the sequence of models as the garment state of the target garment model corresponding to the target object.

As an optional implementation of the embodiment of the present disclosure, the rendering the target garment model according to the illumination information to generate the second image comprises:
generating a light map corresponding to the first image according to the illumination information;
rendering the target garment model according to the light map to generate the second image.

As an optional implementation of the embodiment of the present disclosure, the rendering the target garment model according to the garment state of the target garment model corresponding to the target object and the illumination information to generate the second image comprises:
acquiring material information of the virtual garment;
rendering the target garment model according to the garment state of the target garment model corresponding to the target object, the illumination information and the material information of the virtual garment to generate the second image.

As an optional implementation of the embodiment of the present disclosure, before rendering the target garment model according to the illumination information, the method further comprises:
displaying a garment selecting interface, at least one garment model being displayed on the garment selecting interface;
receiving a selection operation input on the garment selecting interface;
determining a garment model receiving the selection operation as the target garment model.

As an optional implementation of the embodiment of the present disclosure, the method further comprises:
receiving a correction operation on the effect image;
correcting the effect image in response to the correction operation on the effect image.

In a second aspect, an embodiment of the present disclosure provides an image generation apparatus comprising:
an acquisition unit configured to acquire a first image including a target object;
a processing unit configured to perform an illumination estimation on the first image to acquire illumination information of the first image;
a rendering unit configured to render a target garment model according to the illumination information to generate a second image;
a fusion unit configured to fuse the first image and the second image to acquire an effect image for the target object wearing a virtual garment corresponding to the target garment model.

As an optional implementation of the embodiment of the present disclosure, the processing unit is further configured to construct a first model corresponding to the target object according to the first image; determine a garment state of the target garment model corresponding to the target object according to the first model; the rendering unit is specifically configured to render the target garment model according to the garment state of the target garment model corresponding to the target object and the illumination information to generate the second image.

As an optional implementation of the embodiment of the present disclosure, the processing unit is specifically configured to perform a key point detection on the target object to acquire position information of a plurality of key points of the target object; acquire a body shape and/or a posture of the target object according to the position information of the plurality of key points; construct the first model according to the body shape and/or the posture of the target object.

As an optional implementation of the embodiment of the present disclosure, the image generation apparatus further comprises: a model correction unit configured to receive a correction operation on the body shape and/or the posture of the first model; correct the body shape and/or the posture of the first model in response to the correction operation on the body shape and/or the posture of the first model.

As an optional implementation of the embodiment of the present disclosure, the processing unit is specifically configured to construct a second model corresponding to the target object according to an initial state of the target garment model; determine the garment state of the target garment model corresponding to the target object according to the first model and the second model.

As an optional implementation of the embodiment of the present disclosure, the processing unit is specifically configured to generate a sequence of models according to the first model and the second model, the sequence of models including a plurality of models, and the plurality of models gradually changing from the second model to the first model in order; perform a simulation on the target garment model in the initial state based on the first model in the sequence of models to acquire a garment state corresponding to the first model; perform the simulation on the target garment model in a garment state corresponding to the (n−1)th model based on the nth model in the sequence of models to acquire a garment state corresponding to the nth model, n being an integer greater than 1; determine a garment state corresponding to the last model in the sequence of models as the garment state of the target garment model corresponding to the target object.

As an optional implementation of the present disclosure embodiment, the rendering unit is specifically configured to generate a light map corresponding to the first image according to the illumination information; render the target garment model according to the light map to generate the second image.

As an optional implementation of the present disclosure embodiment, the rendering unit is specifically configured to acquire material information of the virtual garment; render the target garment model according to the garment state of the target garment model corresponding to the target object, the illumination information and the material information of the virtual garment to generate the second image.

As an optional implementation of the embodiment of the present disclosure, the processing unit is further configured to, before rendering the target garment model according to the illumination information, display a garment selecting interface, at least one garment model being displayed on the garment selecting interface; receive a selection operation input on the garment selecting interface; determine a garment model receiving the selection operation as the target garment model.

As an optional implementation of the embodiment of the present disclosure, the image generation apparatus further comprises an effect correction unit configured to receive a correction operation on the effect image; correct the effect image in response to the correction operation on the effect image.

In a third aspect, an embodiment of the present disclosure provides an electronic device comprising a memory and a processor, the memory being used to store a computer program; the processor being configured to cause the electronic device to implement the image generation method described in any one of the above implementations when executing the computer program.

In a fourth aspect, an embodiment of the present disclosure provides a computer-readable storage medium which, when the computer program is executed by a computing device, causes the computing device to implement the image generation method described in any one of the above implementations.

In a fifth aspect, an embodiment of the present disclosure provides a computer program product which, when run on a computer, causes the computer to implement the image generation method described in any one of the above implementations.

The image generation method provided by the embodiment of the present disclosure first acquires a first image including a target object, then performs an illumination estimation on the first image to acquire illumination information of the first image, and renders a target garment model according to the illumination information of the first image to generate a second image, and fuses the first image and the second image to generate an effect image for the target object wearing a virtual garment corresponding to the target garment model.

### BRIEF DESCRIPTION OF THE DRAWINGS

The accompanying drawings herein, which incorporate into the specification and constitute a part of the specification, show embodiments conforming to the present disclosure and, together with the specification, serve to explain principles of the present disclosure.

In order to more clearly illustrate technical solutions in the embodiments of the present disclosure or the related technology, the accompanying drawings that need to be invoked in the description of the embodiments or the related technology will be briefly introduced below. It is apparent to a person of ordinary skill in the art that other accompanying drawings can be obtained based on these drawings on the premise of without exerting creative labor.

FIG. 1 is one of flowcharts of steps of an image generation method provided by an embodiment of the present disclosure;

FIG. 2 is another one of flowcharts of steps of an image generation method provided by an embodiment of the present disclosure;

FIG. 3 is a schematic diagram of a first model provided by an embodiment of the present disclosure;

FIG. 4 is a schematic diagram of a second model provided by an embodiment of the present disclosure;

FIG. 5 is a schematic diagram of a sequence of models provided by an embodiment of the present disclosure;

FIG. 6 is a schematic diagram of gradually changing garment states provided by an embodiment of the present disclosure;

FIG. 7 is one of schematic diagrams of a structure of an image generation apparatus provided by an embodiment of the present disclosure;

FIG. 8 is another one of schematic diagrams of a structure of an image generation apparatus provided by an embodiment of the present disclosure;

FIG. 9 is a schematic diagram of a hardware structure of an electronic device provided by an embodiment of the present disclosure.

### DETAILED DESCRIPTION

In order to enable a clearer understanding of the above purposes, features and advantages of the present disclosure, the solutions in the present disclosure will be further described below. It should be noted that embodiments of the present disclosure and features in the embodiments may be combined with each other without a conflict.

Many specific details are set forth in the following description in order to facilitate a full understanding of the present disclosure, but the present disclosure may also be implemented in other ways different from those described herein; obviously, the embodiments in the specification are only some embodiments of the present disclosure and not all embodiments.

In the embodiments of the present disclosure, the words “exemplary” or “for example” and so on are used to denote an example, illustration, or description. Any embodiment or design scheme described as “exemplary” or “for example” in the embodiments of the present disclosure should not be construed as being preferred or advantageous over other embodiments or design schemes. Rather, an invocation of the words “exemplary” or “for example” and so on is intended to present a relevant concept in a specific manner. Furthermore, in the description of embodiments of the present disclosure, unless otherwise specified, “a plurality of” refers to two or more than two.

At present, a generally adopted scheme for Virtual Try-on is to perform an image acquisition on a try-on object, acquire an image of the try-on object, and then fuse the image of the try-on object and an image of a virtual garment to acquire an effect image after the try-on object wears the virtual garment. However, since light source information of the image including the try-on object is light source information in a real environment, but light source information of the image of the virtual garment is light source information manually configured by a developer, so a mismatch between the real light source information and the manually configured light source information often leads to problems such as confusion in the position of the light source in the effect image, uneven illumination and so on, which seriously affects the realism of the try-on effect image.

In view of this, embodiments of the present disclosure provide an image generation method and apparatus for solving the problem of the mismatch between real light source information and manually configured light source information affecting the realism of the effect image.

Usage scenarios of the image generation method provided by an embodiment of the present disclosure are illustrated below.

Scenario 1: the embodiment of the present disclosure may be applicable to a garment trying-on at online platforms such as e-commerce, special effects, and short videos. The implementation process may include: choosing a garment that would like to be tried on in an application or a webpage by a user, and uploading an image containing a target object, and then generating an effect image after the target object wears the garment that he wants to try on by using the pre-constructed garment model and the image generation method provided by the embodiment of the present disclosure, and outputting the effect image.

Scenario 2: the embodiment of the present disclosure may be applicable to a garment try-on at offline platforms such as shopping malls and supermarkets. The implementation process may include: when a target object wants to try on a certain physical garment, performing an image acquisition on the target object by an image acquisition device, acquiring an image containing the target object, and then generating an effect image after the target object wears the garment that he wants to try on by using the pre-constructed garment model and the image generation method provided by the embodiment of the present disclosure, and outputting the effect image.

An embodiment of the present disclosure provides an image generation method. As shown with reference to FIG. 1, the image generation method includes the following steps S11 to S14.
S11: acquiring a first image including a target object.

In some embodiments, an implementation of acquiring the first image may include acquiring the first image including the target object by performing an image acquisition of the target object by an image acquisition means.

In some embodiments, an implementation of acquiring the first image may include receiving the first image including the target object uploaded or imported by a user.

It is to be noted that the target object in the embodiment of the present disclosure may be any entity object, for example, a person, a pet, a mannequin, and other entity objects, and the embodiment of the present disclosure does not make an limitation on this.
S12: performing an illumination estimation on the first image to acquire illumination information of the first image.

Exemplarily, the illumination estimation may be performed on the first image by illumination estimation algorithms such as the Gardner's algorithm, the Dominant Light algorithm, the Multi-illumination algorithm, etc., so as to acquire the illumination information of the first image. The embodiment of the present disclosure does not limit the illumination estimation algorithm for performing the illumination estimation on the first image, as long as light maps corresponding to the first image can be acquired.
S13: rendering a target garment model according to the illumination information to generate a second image.

That is, information such as light source position, illumination color and so on when rendering the target garment model is determined according to the light illumination information of the first image, so as to obtain the second image.

The target garment model in the embodiment of the present disclosure refers to a three-dimensional model of a virtual garment that the target object wants to try on, and the target garment model may be pre-constructed by a developer. Specifically, the target garment model may be a three-dimensional model of a garment such as clothes, a pair of shoes, a bag, jewelry, a scarf, and so on.

Since a target garment model needs to be rendered in the above step S13, the method provided by the embodiment of the present disclosure also needs to determine the target garment model before the above step S13. In some embodiments, the target garment model may be determined based on a selection operation input by the user; and the process for determining the target garment model based on the selection operation input by the user may include the following step 1) to step 3).

Step 1): displaying a garment selecting interface.

Wherein at least one garment model is displayed on the garment selecting interface.

Specifically, two-dimensional images of a plurality of garment models may be displayed on the garment selecting interface for selection by the user.

Step 2): receiving a selection operation input on the garment selecting interface.

Exemplarily, the selection operation may be a mouse operation, a touch-click operation or a voice command.

Step 3): determining a garment model receiving the selection operation as the target garment model.

It is to be noted that since the second image is obtained by rendering the target garment model according to the illumination information of the first image, the second image includes a virtual garment corresponding to the target garment model.
S14: fusing the first image and the second image to acquire an effect image for the target object wearing a virtual garment corresponding to the target garment model.

The embodiment of the present disclosure does not limit the image fusion algorithm used in fusing the first image and the second image, as long as the first image and the second image can be fused to acquire the image.

The image generation method provided by the embodiment of the present disclosure first acquires the first image including the target object, then performs the illumination estimation on the first image to acquire the illumination information of the first image, and renders the target garment model according to the illumination information of the first image to generate the second image, and fuses the first image and the second image to generate the effect image for the target object wearing the virtual garment corresponding to the target garment model. Since the second image in the image generation method provided by the embodiment of the present disclosure is generated by rendering the target garment model according to the illumination information of the first image, the embodiment of the present disclosure can improve a mismatch between the light source information of the first image including the target object and the light source information of the second image including the virtual garment, which in turn affects the realism of the effect image.

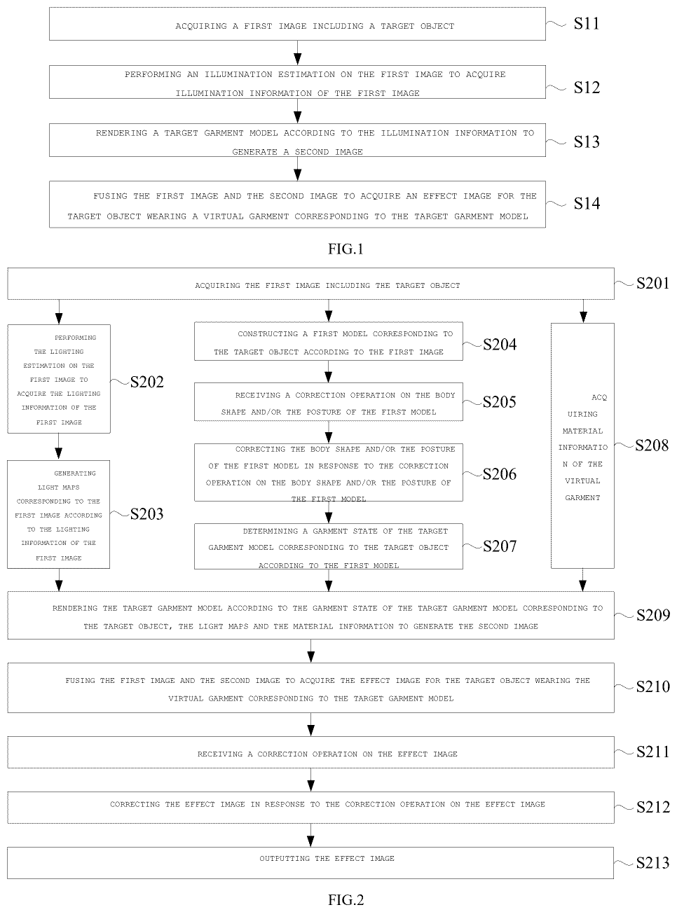

As an extension and refinement of the above embodiment, an embodiment of the present disclosure provides another image generation method. As shown with reference to FIG. 2, the image generation method includes the following step S201 to step S211:
S201: acquiring the first image including the target object.
S202: performing the lighting estimation on the first image to acquire the lighting information of the first image.
S203: generating light maps corresponding to the first image according to the lighting information.

As an optional implementation of the embodiment of the present disclosure, the light maps in the embodiment of the present disclosure may be High Dynamic Range (HDR) light maps.
S204: constructing a first model corresponding to the target object according to the first image.

As an optional implementation of the embodiment of the present disclosure, the above step S204 (constructing the first model corresponding to the target object according to the first image) includes the following step 1 to step 3.

Step 1: performing a key point detection on the target object to acquire position information of a plurality of key points of the target object.

Specifically, in the embodiment of the present disclosure, depending on different target objects, different key point detection algorithms may be adopted to perform the key point detections on the target objects. For example, when the target object is a person, a limb key point detection algorithm may be adopted to detect a key point such as a head, a hand, a foot, an elbow joint, a shoulder joint, a knee joint, and so on, and then the position information of the key point such as the head, the hand, the foot, the elbow joint, the shoulder joint, the knee joint, and so on is acquired.

Step 2: acquiring a body shape and/or a posture of the target object according to the position information of the plurality of key points.

Specifically, the body shape and/or the posture of the target object may be acquired according to relative positions between the plurality of key points. For example, when the target object is a person, the plurality of key points include a head, a hand, a foot, an elbow joint, a shoulder joint, a knee joint, and other key points, then a height of the target object may be determined according to the relative position between the head key point and the foot key point, an arm posture of the target object may be determined according to the relative position between the hand key point and the elbow joint key point, and a shoulder width of the target object may be determined according to the relative position between the left shoulder joint key point and the right shoulder joint key point.

Step 3: constructing the first model according to the body shape and the posture of the target object.

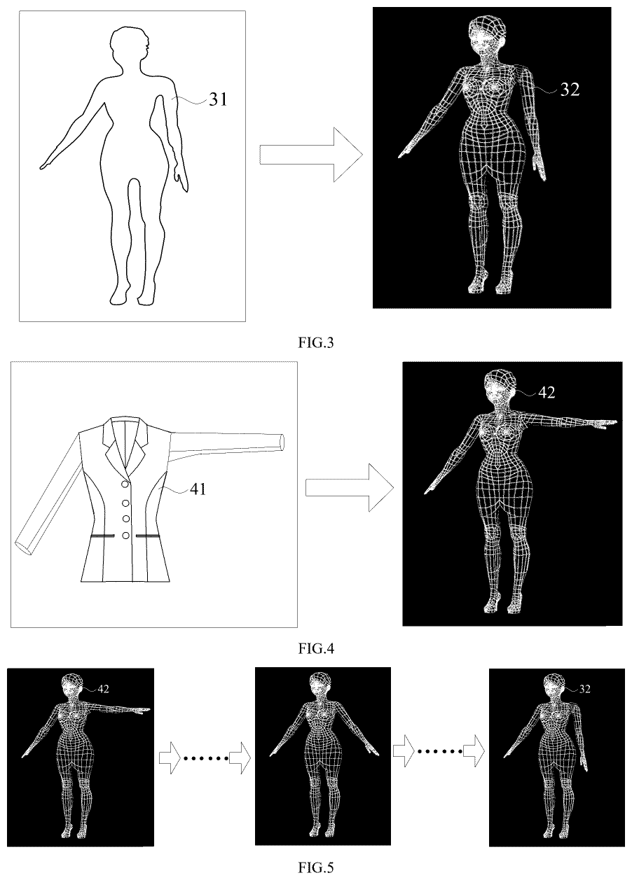

Exemplarily, as shown with reference to FIG. 3, since the first model 32 is constructed according to the body shape and/or the posture of the target object 31, the first model 32 is the same as the body shape/or the posture of the target object 31.
S205: receiving a correction operation on the body shape and/or the posture of the first model.
S206: correcting the body shape and/or the posture of the first model in response to the correction operation on the body shape and/or the posture of the first model.

Since in the above embodiment, the correction operation on the body type and/or the posture input for the first model is further received and the body type and/or the posture of the first model is corrected in response to the correction operation on the first model, the above embodiment can better match the first model with the body type and/or the posture of the target object.
S207: determining a garment state of the target garment model corresponding to the target object according to the first model.

As an optional implementation of the embodiment of the present disclosure, the above step S206 (determining the garment state of the target garment model corresponding to the target object according to the first model) includes the following step a and step b.

Step a: constructing a second model corresponding to the target object according to an initial state of the target garment model.

That is, a model of the target object applicable to the initial state of the target garment model is constructed as the second model.

Exemplarily, as shown with reference to FIG. 4, since the second model 42 is constructed according to the initial state of the target garment model 41, the second model 42 matches the initial state of the target garment model 41.

Step b: determining the garment state of the target garment model corresponding to the target object according to the first model and the second model.

As an optional implementation of the embodiment of the present disclosure, the above step b (determining the garment state of the target garment model corresponding to the target object according to the first model and the second model) includes the following step b1 to step b4.

Step b1: generating a sequence of models according to the first model and the second model.

Wherein the sequence of models includes a plurality of models, and the plurality of models gradually change from the second model to the first model in order.

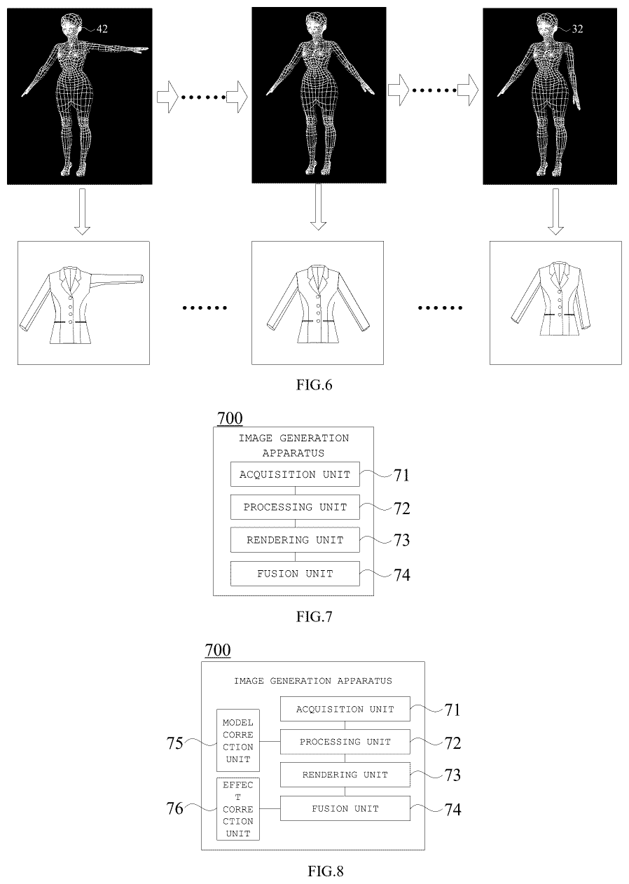

Continuing with the example above, the difference between the first model 32 and the second model 42 is only that the left arm of the first model 32 is in a naturally drooping state, while the left arm of the second model 42 is in a horizontal state, and the rest parts are the same, so the sequence of models generated according to the first model 32 and the second model 42 may include a plurality of models as shown in FIG. 5, and the plurality of models gradually change from the second model 42 to the first model 32 in order.

Step b2: performing a simulation on the target garment model in the initial state based on the first model in the sequence of models to acquire a garment state corresponding to the first model.

Step b3: performing the simulation on the target garment model in a garment state corresponding to the (n−1)th model based on the nth model in the sequence of models to acquire a garment state corresponding to the nth model.

Wherein n is an integer greater than 1.

That is, as shown in FIG. 6, the garment state of the target garment model gradually changes from the initial state (a state matching the second model 42) to the state matching the first model 32.

It should to be noted that, in the embodiment of the present disclosure, performing the simulation on the target garment model based on a model includes not only adapting the target garment model to the body shape and the posture of the model, but also performing a simulation on folds, drape effect and the like of the target garment model.

Step b4: determining a garment state corresponding to the last model in the sequence of models as the garment state of the target garment model corresponding to the target object.

That is, the last model in the sequence of models is the first model, and thus the above step b4 is to determine the garment state corresponding to the first model as the garment state of the target garment model corresponding to the target object.

When the target object differs greatly from the body type and/or the posture of the target garment model in the initial state, if the target garment model is directly transformed, according to the first model, from the initial state to the garment state of the target garment model corresponding to the target object, then an abnormality of the target garment model occurs due to an excessive change in the garment state of the target garment model. In the above embodiment, the sequence of models gradually changing from the second model to the first model in order is generated according to the first model and the second model, and the garment state of the target garment model is gradually changed through the models in the sequence of models, thereby improving the excessive change in the garment state of the target garment model each time it changes, and thus the above embodiment can improve the abnormality caused by the excessive change in the garment state of the target garment model.
S208: acquiring material information of the virtual garment.

In some embodiments, an implementation of acquiring the material information of the virtual garment may include determining preset material information as the material information of the virtual garment.

In some embodiments, an implementation of acquiring the material information of the virtual garment may include outputting a prompt message for prompting the user to make a material selection, receiving a selection operation input by the user, and determining the material information of the virtual garment in response to the selection operation from the user.
S209: rendering the target garment model according to the garment state of the target garment model corresponding to the target object, the light maps and the material information to generate the second image.
S210: fusing the first image and the second image to acquire the effect image for the target object wearing the virtual garment corresponding to the target garment model.
S211: receiving a correction operation on the effect image.
S212: correcting the effect image in response to the correction operation on the effect image.
S213: outputting the effect image.

In some embodiments, an implementation of outputting the effect image includes displaying the effect image by a display.

In some embodiments, an implementation of outputting the effect image includes sending the effect image to a designated device so that a corresponding user can view the effect image.

Based on the same inventive concept, as an implementation of the above method, an embodiment of the present disclosure further provides an image generation apparatus, and this embodiment corresponds to the foregoing method embodiment. For the convenience of reading, the present embodiment will not repeat the details of the foregoing method embodiment one by one, but it should be made clear that the image generation apparatus in the present embodiment is capable of realizing all the contents in the foregoing method embodiment correspondingly.

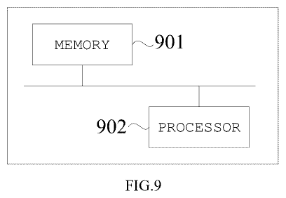

An embodiment of the present disclosure provides an image generation apparatus. FIG. 7 is a schematic diagram of a structure of the image generation apparatus. As shown in FIG. 7, the image generation apparatus 700 includes:
an acquisition unit 71 configured to acquire a first image including a target object;
a processing unit 72 configured to perform an illumination estimation on the first image to acquire illumination information of the first image;
a rendering unit 73 configured to render a target garment model according to the illumination information to generate a second image;
a fusion unit 74 configured to fuse the first image and the second image to acquire an effect image for the target object wearing a virtual garment corresponding to the target garment model.

As an optional implementation of the embodiment of the present disclosure, the processing unit 72 is further configured to construct a first model corresponding to the target object according to the first image; determine a garment state of the target garment model corresponding to the target object according to the first model; the rendering unit 73 is specifically configured to render the target garment model according to the garment state of the target garment model corresponding to the target object and the illumination information to generate the second image.

As an optional implementation of the embodiment of the present disclosure, the processing unit 72 is specifically configured to perform a key point detection on the target object to acquire position information of a plurality of key points of the target object; acquire a body shape and/or a posture of the target object according to the position information of the plurality of key points; construct the first model according to the body shape and/or the posture of the target object.

As an optional implementation of the embodiment of the present disclosure, referring to FIG. 8, the image generation apparatus 800 further includes: a model correction unit 75 configured to receive a correction operation on the body shape and/or the posture of the first model; correct the body shape and/or the posture of the first model in response to the correction operation on the body shape and/or the posture of the first model.

As an optional implementation of the embodiment of the present disclosure, the processing unit 72 is specifically configured to construct a second model corresponding to the target object according to an initial state of the target garment model; determine the garment state of the target garment model corresponding to the target object according to the first model and the second model.

As an optional implementation of the embodiment of the present disclosure, the processing unit 72 is specifically configured to generate a sequence of models according to the first model and the second model, the sequence of models including a plurality of models, and the plurality of models gradually changing from the second model to the first model in order; perform a simulation on the target garment model in the initial state based on the first model in the sequence of models to acquire a garment state corresponding to the first model; perform the simulation on the target garment model in a garment state corresponding to the (n−1)th model based on the nth model in the sequence of models to acquire a garment state corresponding to the nth model, n being an integer greater than 1; determine a garment state corresponding to the last model in the sequence of models as the garment state of the target garment model corresponding to the target object.

As an optional implementation of the present disclosure embodiment, the rendering unit 72 is specifically configured to generate a light map corresponding to the first image according to the illumination information; render the target garment model according to the light map to generate the second image.

As an optional implementation of the present disclosure embodiment, the rendering unit 73 is specifically configured to acquire material information of the virtual garment; render the target garment model according to the garment state of the target garment model corresponding to the target object, the illumination information and the material information of the virtual garment to generate the second image.

As an optional implementation of the embodiment of the present disclosure, the processing unit 72 is further configured to, before rendering the target garment model according to the illumination information, display a garment selecting interface, at least one garment model being displayed on the garment selecting interface; receive a selection operation input on the garment selecting interface; determine a garment model receiving the selection operation as the target garment model.

As an optional implementation of the embodiment of the present disclosure, as shown with reference to FIG. 8, the image generation apparatus 800 further includes an effect correction unit 76 configured to receive a correction operation on the effect image; correct the effect image in response to the correction operation on the effect image.

The image generation apparatus provided by the present embodiment can perform the image generation method provided by the above method embodiment, the implementation principle and technical effect of which are similar and will not be repeated herein.

Based on the same inventive concept, an embodiment of the present disclosure further provides an electronic device. FIG. 9 is a schematic diagram of a structure of the electronic device provided by the embodiment of the present disclosure. As shown in FIG. 9, the electronic device provided by the present embodiment includes a memory 901 and a processor 902, the memory 901 is used to store a computer program; the processor 902 is configured to perform the image generation method provided by the above embodiment when executing the computer program.

Based on the same inventive concept, an embodiment of the present disclosure further provides a computer-readable storage medium having a computer program stored thereon which, when executed by a processor, causes the computing device to implement the image generation method provided by the above embodiment.

Based on the same inventive concept, an embodiment of the present disclosure further provides a computer program product which, when run on a computer, causes the computing device to implement the image generation method provided by the above embodiment.

It should be appreciated by those skilled in the art that the embodiment of the present disclosure may be provided as a method, a system, or a computer program product. Thus, the present disclosure may take a form of an entire hardware embodiment, an entire software embodiment, or an embodiment that combines software and hardware aspects. Further, the present disclosure may take a form of a computer program product implemented on one or more computer-usable storage media containing computer-usable program codes therein.

The processor may be a Central Processing Unit (CPU), and may be a general-purpose processor, a Digital Signal Processor (DSP), an Application Specific Integrated Circuit (ASIC), a Field-Programmable Gate Array (FPGA) or another programmable logic device, a discrete gate or a transistor logic device, a discrete hardware component, and the like. The general-purpose processor may be a microprocessor, or the processor may also be any conventional processor, etc.

The memory may include a non-permanent memory in a computer-readable medium, a Random Access Memory (RAM) and/or non-volatile memory, such as Read-Only Memory (ROM) or flash memory. The memory is an example of a computer readable medium.

The computer-readable media include permanent and non-permanent, removable and non-removable storage media. The storage media may be implemented by any method or technique for storing information, which may be computer-readable instructions, data structures, modules of a program, or other data. Examples of storage media for computers include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cartridge tape, disk storage or other magnetic storage device or any other non-transmission medium that can be used to store information that can be accessed by a computing device. According to the definition herein, the computer readable media do not include transitory computer readable media, such as modulated data signals and carriers.

Finally, it should be noted that the above embodiment are only used to illustrate the technical solutions of the present disclosure, and not to limit them; although the present disclosure has been described in detail with reference to the foregoing various embodiments, a person of ordinary skill in the art should understand that, it is still possible to modify the technical solutions recited in the foregoing embodiments, or to replace some or all of the technical features therein with equivalents; and these modifications or replacements do not make the essence of the corresponding technical solutions depart from the scope of the technical solutions in the various embodiments of the present disclosure.

1. An image generation method, comprising:
acquiring a first image including a target object;
acquiring illumination information of the first image;
rendering a target resource model according to the illumination information to generate a second image; and
fusing the first image and the second image to acquire an effect image for the target object which is added with a virtual resource corresponding to the target resource model.

2. The method according to claim 1, wherein the method further comprises:
constructing a first model corresponding to the target object according to the first image;
determining a resource state of the target resource model corresponding to the target object according to the first model;
the rendering the target resource model according to the illumination information to generate the second image comprises rendering the target resource model according to the resource state of the target resource model corresponding to the target object and the illumination information to generate the second image.

3. The method according to claim 2, wherein the constructing the first model corresponding to the target object according to the first image comprises:
performing a key point detection on the target object to acquire position information of a plurality of key points of the target object;
acquiring at least one of a body shape and a posture of the target object according to the position information of the plurality of key points;
constructing the first model according to the at least one of the body shape and the posture of the target object.

4. The method according to claim 3, wherein the method further comprises:
receiving a correction operation on the at least one of the body shape and the posture of the first model;
correcting the at least one of the body shape and the posture of the first model in response to the correction operation on the at least one of the body shape and the posture of the first model.

5. The method according to claim 3, wherein the determining the resource state of the target resource model corresponding to the target object according to the first model comprises:
constructing a second model corresponding to the target object according to an initial state of the target resource model;
determining the resource state of the target resource model corresponding to the target object according to the first model and the second model.

6. The method according to claim 5, wherein the determining the resource state of the target resource corresponding to the target object according to the first model and the second model comprises:
generating a sequence of models according to the first model and the second model, the sequence of models including a plurality of models, and the plurality of models gradually changing from the second model to the first model in order;
performing a simulation on the target resource model in the initial state based on the first model in the sequence of models to acquire a resource state corresponding to the first model;
performing the simulation on the target resource model in resource state corresponding to the (n−1)th model based on the nth model in the sequence of models to acquire a resource state corresponding to the nth model, n being an integer greater than 1;
determining a resource state corresponding to the last model in the sequence of models as the resource state of the target garment model corresponding to the target object.

7. The method according to claim 1, wherein the rendering the target resource model according to the illumination information to generate the second image comprises:
generating a light map corresponding to the first image according to the illumination information;
rendering the target resource model according to the light map to generate the second image.

8. The method according to claim 2, wherein the rendering the target resource model according to the resource state of the target resource model corresponding to the target object and the illumination information to generate the second image comprises:
acquiring material information of the virtual resource;
rendering the target resource model according to the resource state of the target resource model corresponding to the target object, the illumination information and the material information of the virtual resource to generate the second image.

9. The method according to claim 1, wherein before rendering the target resource according to the illumination information, the method further comprises:
displaying a resource selecting interface, at least one resource model being displayed on the resource selecting interface;
receiving a selection operation input on the resource selecting interface;
determining a resource model receiving the selection operation as the target resource model.

10. The method according to claim 1, wherein the method further comprises:
receiving a correction operation on the effect image;
correcting the effect image in response to the correction operation on the effect image.

11. (canceled)

12. An electronic device, comprising a memory and a processor, the memory being used to store a computer program; the processor being configured to cause the electronic device to implement an image generation method comprising:
acquiring a first image including a target object;
acquiring illumination information of the first image;
rendering a target resource model according to the illumination information to generate a second image; and
fusing the first image and the second image to acquire an effect image for the target object which is added with a virtual resource corresponding to the target resource model.

13. A non-transitory computer-readable storage medium having a computer program stored thereon which, when executed by a computing device, causes the computing device to implement an image generation method according to comprising:
acquiring a first image including a target object;
acquiring illumination information of the first image;
rendering a target resource model according to the illumination information to generate a second image; and
fusing the first image and the second image to acquire an effect image for the target object which is added with a virtual resource corresponding to the target resource model.

14-15. (canceled)

16. The electronic device according to claim 12, wherein the method further comprises:
constructing a first model corresponding to the target object according to the first image;
determining a resource state of the target resource model corresponding to the target object according to the first model;
the rendering the target resource model according to the illumination information to generate the second image comprises rendering the target resource model according to the resource state of the target resource model corresponding to the target object and the illumination information to generate the second image.

17. The electronic device according to claim 16, wherein the constructing the first model corresponding to the target object according to the first image comprises:
performing a key point detection on the target object to acquire position information of a plurality of key points of the target object;
acquiring at least one of a body shape and a posture of the target object according to the position information of the plurality of key points;
constructing the first model according to the at least one of the body shape and the posture of the target object.

18. The electronic device according to claim 17, wherein the determining the resource state of the target resource model corresponding to the target object according to the first model comprises:
constructing a second model corresponding to the target object according to an initial state of the target resource model;
determining the resource state of the target resource model corresponding to the target object according to the first model and the second model.

19. The electronic device according to claim 18, wherein the determining the resource state of the target resource model corresponding to the target object according to the first model and the second model comprises:
generating a sequence of models according to the first model and the second model, the sequence of models including a plurality of models, and the plurality of models gradually changing from the second model to the first model in order;
performing a simulation on the target resource model in the initial state based on the first model in the sequence of models to acquire a resource state corresponding to the first model;
performing the simulation on the target resource model in a resource state corresponding to the (n−1)th model based on the nth model in the sequence of models to acquire a resource state corresponding to the nth model, n being an integer greater than 1;
determining a resource state corresponding to the last model in the sequence of models as the resource state of the target resource model corresponding to the target object.

20. The non-transitory computer-readable storage medium according to claim 13, wherein the method further comprises:
constructing a first model corresponding to the target object according to the first image;
determining a resource state of the target resource model corresponding to the target object according to the first model;
the rendering the target resource model according to the illumination information to generate the second image comprises rendering the target resource model according to the resource state of the target resource model corresponding to the target object and the illumination information to generate the second image.

21. The non-transitory computer-readable storage medium according to claim 20, wherein the constructing the first model corresponding to the target object according to the first image comprises:
performing a key point detection on the target object to acquire position information of a plurality of key points of the target object;
acquiring at least one of a body shape and a posture of the target object according to the position information of the plurality of key points;
constructing the first model according to the at least one of the body shape and the posture of the target object.

22. The non-transitory computer-readable storage medium according to claim 21, wherein the determining the resource state of the target resource model corresponding to the target object according to the first model comprises:
constructing a second model corresponding to the target object according to an initial state of the target resource model;
determining the resource state of the target resource model corresponding to the target object according to the first model and the second model.

23. The method according to claim 1, wherein the virtual resource is a virtual garment, and the target resource model is a target garment model.
